(19) United States
(12) Patent Application Publication
(10) Pub. No.: US 2015/0269681 A1
(43) Pub. Date: Sep. 24, 2015

(54) COMPETITIVE BIDDING PLATFORM FOR VEHICLE INSURANCE

(71) Applicant: HTI IP, LLC, Atlanta, GA (US)

(72) Inventor: Dedeepya KALINADHABHOTLA, Atlanta, GA (US)

(73) Assignee: HTI IP, LLC, Atlanta, GA (US)

(21) Appl. No.: 14/218,298

(22) Filed: Mar. 18, 2014

(51) Int. Cl. G06Q 40/08; G06Q 30/08

(52) U.S. Cl. CPC G06Q 40/08; G06Q 30/08

(57) ABSTRACT

A device may receive a request for a vehicle insurance bid including information that identifies a driver and information that identifies a vehicle associated with the driver. The device may identify an insurer that is to be provided with bidding information associated with the driver and the vehicle. The device may determine a subscription type associated with the insurer that may indicate a scope of the bidding information that is to be provided to the insurer. The device may determine the bidding information based on the subscription type, the request, and driver information associated with the driver and/or the vehicle. The device may provide the bidding information to an insurer device associated with the insurer. The device may receive a bid after providing the bidding information. The device may provide the bid such that the driver can purchase vehicle insurance associated with the bid.

### BACKGROUND

A driver may obtain vehicle insurance (e.g., automobile insurance) for a vehicle associated with the driver. The vehicle insurance may grant, to the driver, financial protection and/or legal protection associated with damage resulting from a collision involving the vehicle, bodily injury resulting from a collision involving the vehicle, theft of the vehicle, and/or another type of risk and/or incident associated with the vehicle.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for receiving and storing driver information associated with a driver;

FIG. 5 is diagram of an example implementation relating to the example process shown in FIG. 4;

FIG. 6 is a flow chart of an example process for providing bidding information, associated with a vehicle insurance bid request, to an insurer based on a subscription type associated with the insurer;

FIGS. 7A-7C are diagrams of an example implementation relating to the example process shown in FIG. 6;

FIG. 8 is a flow chart of an example process for receiving and providing vehicle insurance bids associated with a driver; and

FIG. 9 is diagram of an example implementation relating to the example process shown in FIG. 8.

### DETAILED DESCRIPTION

The following detailed description of example implementations refers to the accompanying drawings. The same reference numbers in different drawings may identify the same or similar elements.

A driver may wish to obtain vehicle insurance that offers protection (e.g., financial protection, legal protection, etc.) for the driver and a vehicle associated with the driver. In some cases, multiple insurers may offer (e.g., for purchase) vehicle insurance that satisfies the driver's vehicle insurance needs. As such, the driver may wish to determine a cost of the vehicle insurance available through the multiple insurers (e.g., to compare vehicle insurance costs, to determine the vehicle insurance with the lowest cost, etc.). However, the driver may be required to seek out (e.g., by navigating an insurer website, by calling the insurer, by visiting the insurer's office, etc.) an individual vehicle insurance quote from each of the multiple insurers in order to determine the cost of the vehicle insurance made available through each insurer, which may be time consuming and inefficient for the driver.

Implementations described herein may allow a driver to provide (e.g., via a single website) information associated with vehicle insurance that the driver wishes to obtain, and may allow the driver to receive multiple vehicle insurance bids from multiple insurers at one time. In this way, the driver may determine a cost of the vehicle insurance made available through each insurer without seeking out a vehicle insurance quote from each insurer individually.

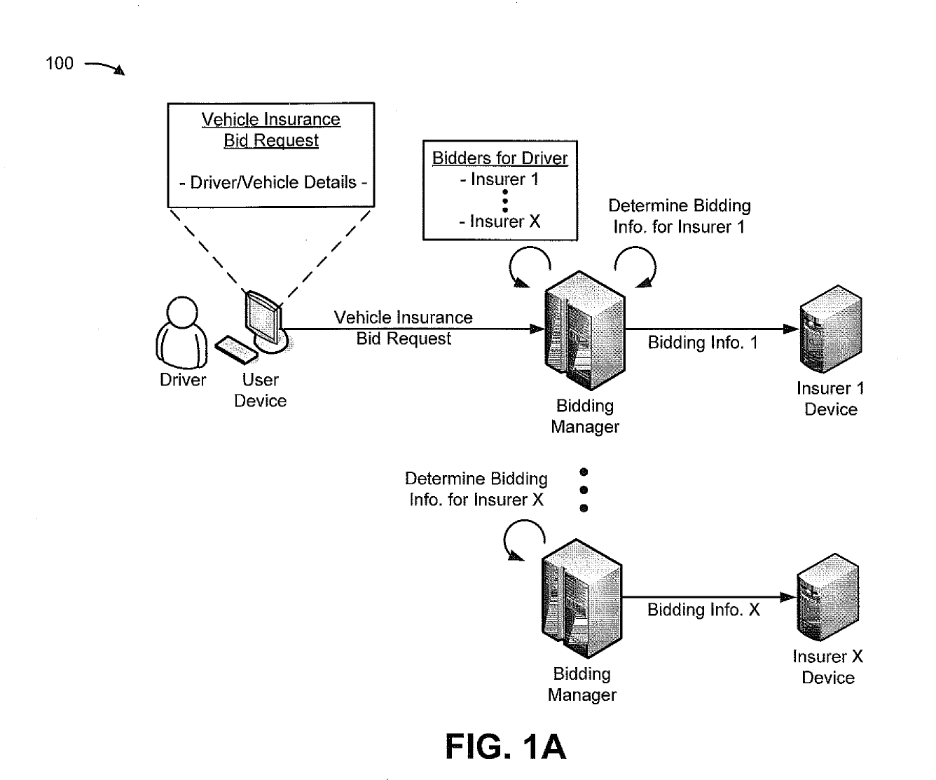

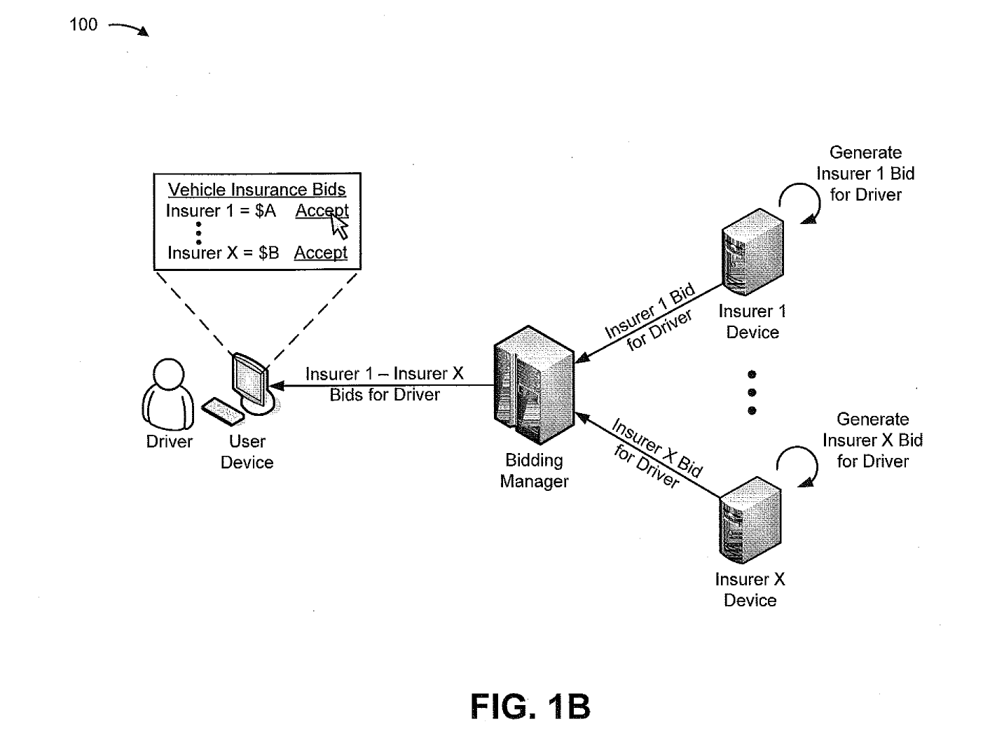

FIGS. 1A and 1B are diagrams of an overview of an example implementation 100 described herein. For the purposes of FIGS. 1A and 1B, assume that a driver wishes to obtain vehicle insurance for a vehicle associated with the driver. Further, assume that a bidding manager hosts a website associated with receiving a vehicle insurance bid request (e.g., associated with the driver), and providing a set of vehicle insurance bids, received from multiple insurers, such that the driver may view the set of vehicle insurance bids via the website (e.g., and purchase vehicle insurance from a particular insurer based on the set of vehicle insurance bids).

As shown in FIG. 1A, the driver may provide (e.g., via a user device) a vehicle insurance bid request that includes information associated with the driver and information associated with the vehicle. As further shown, the user device may send the vehicle insurance bid request to the bidding manager. As shown, the bidding manager may determine a set of insurers, insurer 1 through insurer X (X>1), each of which may provide a vehicle insurance bid associated with the driver.

As further shown, the bidding manager may determine (e.g., based on the vehicle insurance bid request, based on information stored by a driver information device, based on information associated with insurer 1, etc.) first bidding information (e.g., bidding information 1), associated with the driver, that is to be provided to a device associated with insurer 1 (shown as insurer device 1). As shown, the bidding manager may provide bidding information 1 to insurer device 1.

As further shown, the bidding manager may also determine (e.g., based on the vehicle insurance bid request, based on information stored by the driver information device, based on information associated with insurer X, etc.) second bidding information (e.g., bidding information X), associated with the driver, that is to be provided to a device associated with insurer X (shown as insurer device X). As shown, the bidding manager may provide bidding information X to insurer device X. In some implementations, bidding information 1 may be different than bidding information X (e.g., depending on a subscription type associated with insurer 1 and/or a subscription type associated with insurer X that indicates a scope of bidding information that is to be provided to each insurer).

As shown in FIG. 1B, insurer device 1 may generate, based on bidding information 1, an insurer 1 vehicle insurance bid (e.g., insurer 1 bid) associated with the driver and may provide insurer 1 bid to the bidding manager. As further shown, insurer device X may generate, based on bidding information X, an insurer X vehicle insurance bid (e.g., insurer X bid) associated with the driver. As shown, the bidding manager may receive the insurer 1 bid and may receive the insurer X bid, and may provide the insurer 1 bid and the insurer X bid to the user device.

As shown, the user device may display (e.g., via the website) information associated with the insurer 1 bid and information associated with the insurer X bid, and the user may view the vehicle insurance bids and/or, may accept an insurer bid (e.g., and purchase vehicle insurance based on the accepted bid). In this way, a driver may provide (e.g., via a single website) information associated with vehicle insurance that the driver wishes to obtain, the driver may view multiple vehicle insurance bids from multiple insurers at one time (e.g., via the website). In this manner, the driver may determine a cost of the vehicle insurance made available through each insurer without the driver seeking out a vehicle insurance quote from each insurer individually. While the systems and/or methods described herein are described in terms of vehicle insurance, these systems and/or methods could also apply to other types insurance.

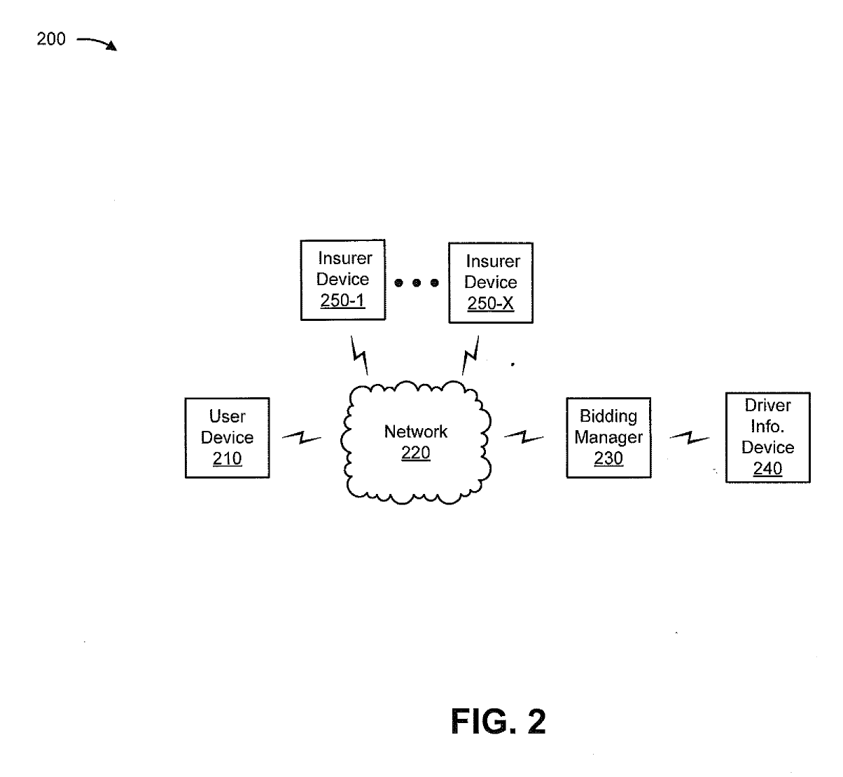

FIG. 2 is a diagram of an example environment 200 in which systems and/or methods described herein may be implemented. As shown in FIG. 2, environment 200 may include a user device 210, a network 220, a bidding manager 230, a driver information device 240, and a set of insurer devices 250-1 through 250-X (X≧1) (hereinafter collectively referred to as “insurer devices 250,” and individually as “insurer device 250”).

User device 210 may include a device capable of communicating with other devices (e.g., bidding manager 230) via a network (e.g., network 220), and/or capable of receiving information provided by another device (e.g., bidding manager 230). For example, user device 210 may include a computing device, such as a laptop computer, a tablet computer, a handheld computer, a desktop computer, a mobile phone (e.g., a smart phone, a radiotelephone, etc.), a personal digital assistant, or a similar device. In some implementations, user device 210 may be capable of receiving (e.g., via a keyboard, via a touch screen, etc.) user input associated with a vehicle insurance bid request.

Network 220 may include one or more wired and/or wireless networks. For example, network 220 may include a wireless local area network (WLAN), a local area network (LAN), a wide area network (WAN), a metropolitan area network (MAN), a telephone network (e.g., the Public Switched Telephone Network (PSTN)), a cellular network, a public land mobile network (PLMN), an ad hoc network, an intranet, the Internet, a fiber optic-based network, or a combination of these or other types of networks. In some implementations, network 220 may allow communication between devices, such as user device 210, bidding manager 230, driver information device 240, and/or insurer devices 250.

Bidding manager 230 may include one or more devices capable of managing a vehicle insurance bidding process associated with a driver and one or more insurers. For example, bidding manager 230 may include a server device or a collection of server devices. In some implementations, bidding manager 230 may be capable of receiving (e.g., from user device 210) a vehicle insurance bid request associated with the driver, determining and providing (e.g., to insurer devices 250) bidding information associated with the driver, receiving (e.g., from insurer devices 250) vehicle insurance bids, and providing the vehicle insurance bids to the driver (e.g., via user device 210). Additionally, or alternatively, bidding manager 230 may be capable of determining driver information, associated with the driver, based on information stored by driver information device 240.

Driver information device 240 may include one or more devices capable of receiving, processing, storing, and/or providing driver information associated with a driver of a vehicle. For example, driver information device 240 may include a server device or a collection of server devices. In some implementations, driver information device 240 may be capable of receiving driver information from user device 210, bidding manager 230, and/or another source of driver information. Additionally, or alternatively, driver information device 240 may be capable of categorizing, organizing, classifying, and/or storing the driver information (e.g., in a data structure). Additionally, or alternatively, driver information device 240 may be capable of providing the driver information to another device, such as bidding manager 230.

Insurer device 250 may include one or more devices, associated with an insurer, capable of generating a vehicle insurance bid associated with a driver. For example, insurer device 250 may include a server device or a collection of server devices. In some implementations, a particular insurer device 250 may be associated with a particular insurer (e.g., while another insurer device 250 may be associated with another insurer). In some implementations, insurer device 250 may be capable of receiving (e.g., from bidding manager 230) bidding information associated with the driver, generating the vehicle insurance bid associated with the driver, and providing the vehicle insurance bid to bidding manager 230.

The number of devices and networks shown in FIG. 2 is provided for explanatory purposes. In practice, there may be additional devices and/or networks, fewer devices and/or networks, different devices and/or networks, or differently arranged devices and/or networks than those shown in FIG. 2. Furthermore, two or more of the devices shown in FIG. 2 may be implemented within a single device, or a single device shown in FIG. 2 may be implemented as multiple, distributed devices. Additionally, one or more of the devices of environment 200 may perform one or more functions described as being performed by another one or more of the devices of environment 200. Devices of environment 200 may interconnect via wired connections, wireless connections, or a combination of wired and wireless connections.

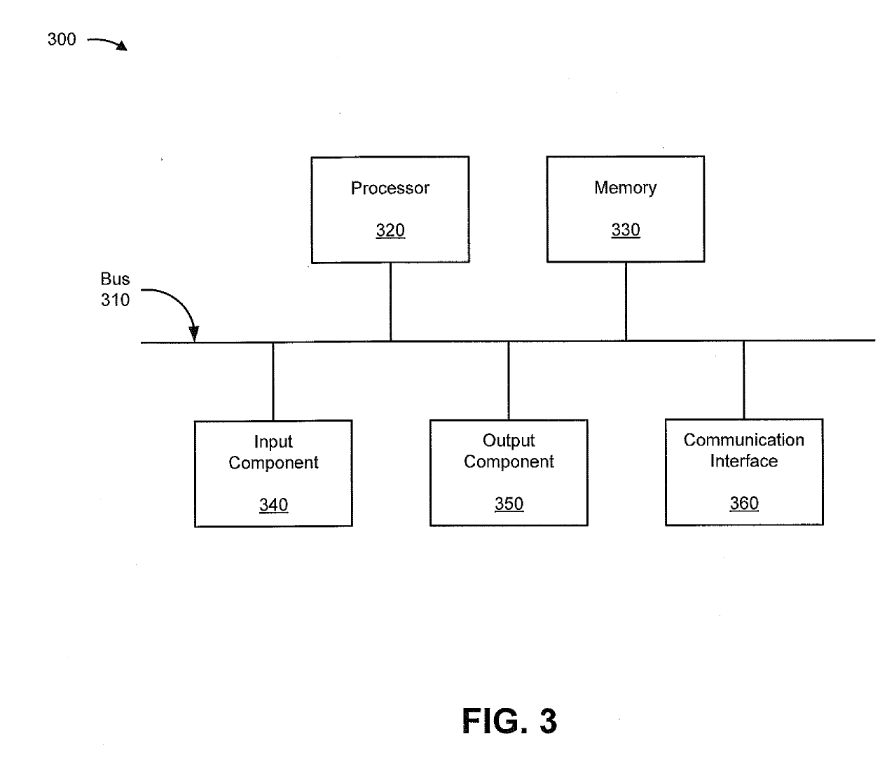

FIG. 3 is a diagram of example components of a device 300. Device 300 may correspond to user device 210, bidding manager 230, driver information device 240, and/or insurer device 250. Additionally, or alternatively, each of user device 210, bidding manager 230, driver information device 240, and/or insurer device 250 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing component (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash memory, a magnetic memory, an optical memory, etc.) that stores information and/or instructions for use by processor 320.

Input component 340 may include any component that permits a user to input information to device 300 (e.g., a keyboard, a keypad, a mouse, a button, a switch, etc.). Output component 350 may include any component that outputs information from device 300 (e.g., a display, a speaker, one or more light-emitting diodes (“LEDs”), etc.).

Communication interface 360 may include any transceiver-like component, such as a transceiver and/or a separate receiver and transmitter, that enables device 300 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

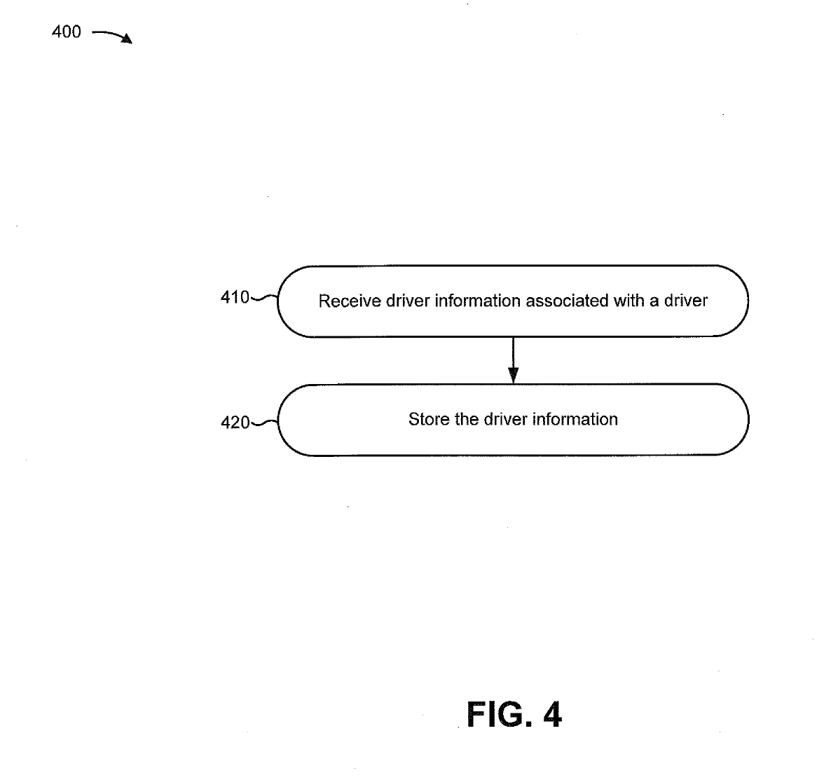

FIG. 4 is a flow chart of an example process 400 for receiving and storing driver information associated with a driver. In some implementations, one or more process blocks of FIG. 4 may be performed by driver information device 240. In some implementations, one or more process blocks of FIG. 4 may be performed by another device or a group of devices separate from or including driver information device 240, such as bidding manager 230.

As shown in FIG. 4, process 400 may include receiving driver information associated with a driver (block 410). For example, driver information device 240 may receive driver information associated with a driver. In some implementations, driver information device 240 may receive the driver information when the driver information is provided to driver information device 240, as discussed below. Additionally, or alternatively, driver information device 240 may receive the driver information based on a request provided by driver information device 240 to another device (e.g., another device that stores the driver information).

Driver information may include information, associated with a driver, that may be used to generate a vehicle insurance bid associated with the driver and a vehicle associated with the driver. For example, the driver information may include driving behavior information determined from the driver driving the vehicle (e.g., vehicle acceleration information, vehicle speed information, location information, vehicle heading information, etc.), usage and/or mileage information related to the vehicle (e.g., an odometer reading, daily mileage information, average daily mileage information, average annual mileage information, etc.), biographical information associated with the driver (e.g., a driver age, a driver marital status, a driver gender, a driver birth date, etc.), a risk prediction associated with the driver (e.g., a credit score of the driver, a driver health prediction, etc.), and/or another type of information associated with the driver and/or the vehicle.

In some implementations, the driver information may be based on information collected, determined, and/or gathered by a device associated with the vehicle. For example, a telematics device (e.g., a device that connects to an on-board diagnostics (OBD) port of the vehicle), may collect driver information (e.g., vehicle acceleration information, vehicle speed information, etc.) while the driver is driving the vehicle, and the telematics device may provide (e.g., via network 220) the driver information to driver information device 240. As another example, a mobile device (e.g., a smart phone, a tablet, etc.), associated with the driver, may collect driver information while the driver is driving the vehicle, and may provide the driver information to driver information device 240.

Additionally, or alternatively, the driver information may be based on information determined by another source. For example, the driver may take the vehicle to a vehicle service entity (e.g., a business that repairs and/or services the vehicle), and the vehicle service entity may gather driver information associated with the vehicle (e.g., an odometer reading, a number of days since the vehicle was last serviced, etc.). In this example, a device associated with the vehicle service entity (e.g., a server device that the gathers driver information when the vehicle is brought in for service) may provide (e.g., via network 220) the driver information to driver information device 240.

Additionally, or alternatively, the driver information may be based on information stored by another device. For example, a device may store biographical information associated with a driver, and the device may provide the biographical information to driver information device 240. As another example, another device may store credit score information associated with a driver, and the other device may provide the credit score information to driver information device 240. In other words, the driver information may be known, and may be provided to driver information device 240.

As further shown in FIG. 4, process 400 may include storing the driver information (block 420). For example, driver information device 240 may store the driver information. In some implementations, driver information device 240 may store the driver information when driver information device 240 receives the driver information (e.g., after driver information device 240 receives the driver information).

In some implementations, driver information device 240 may store the driver information in a memory location (e.g., a RAM, a hard disk, etc.) of driver information device 240. Additionally, or alternatively, driver information device 240 may provide the driver information to another device for storage.

In some implementations, driver information device 240 may store information associated with the driver information, such as a driver identifier (e.g., a driver name, a driver identification number, etc.) that identifies the driver associated with the driver information (e.g., such that driver information device 240 may determine driver information, associated with the driver, based on the driver identifier). Additionally, or alternatively, driver information device 240 may store a vehicle identifier (e.g., vehicle identification number, a vehicle name, a vehicle license plate number, a vehicle make, a vehicle model, etc.) associated with the driver information and the driver.

In some implementations, driver information device 240 may identify a category of the driver information, and may store the driver information based on the category. For example, driver information device 240 may receive driver information that includes an odometer reading of the vehicle associated with the driver, may determine that the odometer reading is associated with a particular category (e.g., usage and/or mileage information), and may store the driver information based on the particular category (e.g., when usage and/or mileage information is to be stored in a particular memory location, etc.). In some implementations, driver information device 240 may categorize the driver information such that driver information device 240 may be capable of providing (e.g., to bidding manager 230, to insurer device 250) only driver information associated with the particular category (e.g., when insurer device 250 is to be provided with only driver information associated with the particular category).

Although FIG. 4 shows example blocks of process 400, in some implementations, process 400 may include additional blocks, different blocks, fewer blocks, or differently arranged blocks than those depicted in FIG. 4. Additionally, or alternatively, one or more of the blocks of process 400 may be performed in parallel.

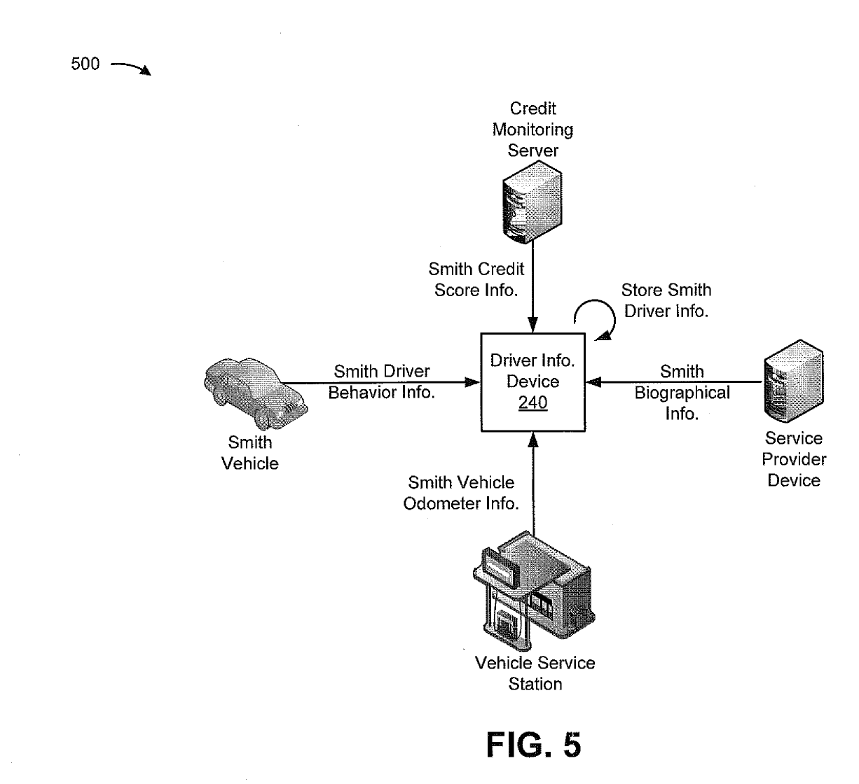

FIG. 5 is a diagram of an example implementation 500 relating to example process 400 shown in FIG. 4. For the purposes of example implementation 500, assume that driver information device 240 is configured to receive driver information associated with a driver (e.g., Smith) and a vehicle associated with the driver. Further, assume that driver information device 240 is configured to store the driver information based on a category associated with the driver information.

As shown in FIG. 5, assume that a telematics device (e.g., connected to the Smith vehicle) collects driver information associated with driver behavior of the driver (e.g., vehicle acceleration information, vehicle speed information, etc.) while the driver is driving the vehicle. As shown, the telematics device may provide the driver information to driver information device 240.

As also shown, a vehicle service station (e.g., that services the Smith vehicle) may gather driver information associated with vehicle mileage and/or usage (e.g., a vehicle odometer reading) and may provide (e.g., via a device associated with the vehicle service station) the driver information to driver information device 240.

As further shown in FIG. 5, a credit monitoring server device may determine, receive, and/or gather driver information indicating a risk prediction associated with the driver (e.g., a driver credit score, a driver credit history, etc.), and may provide the driver information to driver information device 240.

As further shown, a service provider device (e.g., included in a network associated with driver information device 240 and bidding manager 230) may determine, receive, and/or gather driver information that includes biographical information associated with the driver (e.g., a driver age, a driver gender, a driver date of birth, etc.), and may provide the driver information to driver information device 240.

As further shown, driver information device 240 may receive the driver information, associated with the driver and the vehicle, provided by the telematics device, the vehicle service station, the credit monitoring server device, and/or the service provider device, and may store the driver information along with an indication (e.g., a driver identifier that identifies Smith) that the driver information is associated with the driver. Driver information device 240 may also determine a category associated with the driver information (e.g., driving behavior information, vehicle mileage and/or usage information, driver biographical information, risk prediction information, etc.), and may store the driver information accordingly.

As indicated above, FIG. 5 is provided merely as an example. Other examples are possible and may differ from what was described with regard to FIG. 5.

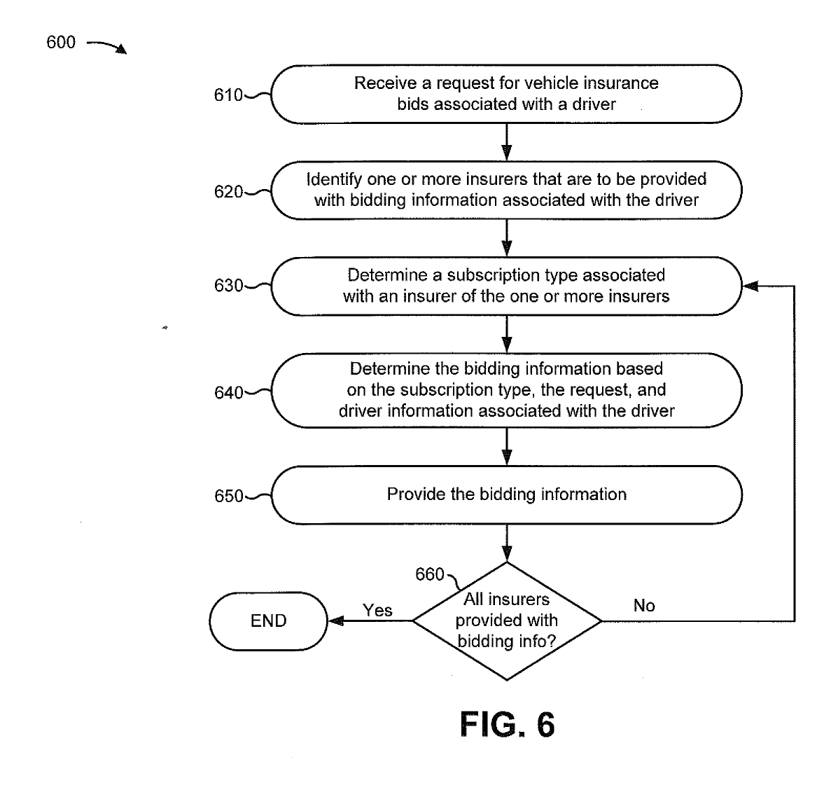

FIG. 6 is a flow chart of an example process 600 for providing bidding information, associated with a vehicle insurance bid request, to an insurer based on a subscription type associated with the insurer. In some implementations, one or more process blocks of FIG. 6 may be performed by bidding manager 230. In some implementations, one or more process blocks of FIG. 6 may be performed by another device or a group of devices separate from or including bidding manager 230, such as driver information device 240.

As shown in FIG. 6, process 600 may include receiving a request for vehicle insurance bids associated with a driver (block 610). For example, bidding manager 230 may receive, from user device 210, a request for vehicle insurance bids (herein referred to as a “bid request”) associated with a driver. In some implementations, bidding manager 230 may receive the bid request when user device 210 provides the bid request (e.g., after user device 210 provides the request). Additionally, or alternatively, bidding manager 230 may receive the bid request when the driver, associated with user device 210, provides (e.g., via user device 210) information associated with the bid request (e.g., after the driver provides user input associated with the bid request).

A request for vehicle insurance bids may include a request indicating that a driver wishes to view (e.g., via user device 210) bids for vehicle insurance available from one or more insurers. In some implementations, the bid request may include information associated with the driver requesting the vehicle insurance bids. For example, the bid request may include a driver name, a driver date of birth, a driver home address, a driver phone number, a driver social security number, a driver gender, a driver marital status, and/or other information associated with the driver. Additionally, or alternatively, the bid request may include information associated with the vehicle associated with the driver. For example, the bid request may include a vehicle identification number (VIN), a vehicle make, a vehicle model, a vehicle model year, a vehicle mileage, a length of time that the driver has owned the vehicle, an indication whether the driver is the only driver of the vehicle, and/or other information associated with the vehicle. Additionally, or alternatively, the bid request may include information indicating a type of vehicle insurance sought by the driver (e.g., liability insurance, comprehensive insurance, collision insurance, personal injury insurance, uninsured motorist insurance, etc.)

In some implementations, the driver may input (e.g., via user device 210) information associated with the bid request based on information associated with bidding manager 230. For example, bidding manager 230 may host a website associated with submitting the bid request, and the driver may access (e.g., via user device 210) the website. In this example, the user may provide input associated with the bid request via a user interface associated with the website (e.g., the user may fill out a bid request form displayed via the website hosted by bidding manager 230).

In some implementations, the driver may provide the input associated with the bid request, and may provide an indication (e.g., by clicking a button, by selecting a menu item) indicating that user device 210 is to provide the bid request to bidding manager 230. User device 210 may then provide the bid request to bidding manager 230, and bidding manager 230 may receive the bid request.

As further shown in FIG. 6, process 600 may include identifying one or more insurers that are to be provided with bidding information associated with the driver (block 620). For example, bidding manager 230 may identify one or more insurers that are to be provided with bidding information (e.g., via insurer devices 250) associated with the driver. In some implementations, bidding manager 230 may identify the one or more insurers when bidding manager 230 receives the bid request (e.g., after bidding manager 230 receives the bid request). Additionally, or alternatively, bidding manager 230 may identify the one or more insurers when bidding manager 230 receives information, indicating that bidding manager 230 is to identify the one or more insurers, from another device (e.g., user device 210, driver information device 240, etc.).

Bidding information may include information, associated with a driver that may be used (e.g., by insurer device 250 associated with an insurer) to generate a vehicle insurance bid. Details regarding determining bidding information associated with the driver are discussed below with respect to block 640. An insurer, that is to be provided with bidding information associated with a driver, may include an insurer that generates a vehicle insurance bid based on being provided with the bidding information, and provides the vehicle insurance bid to bidding manager 230.

In some implementations, bidding manager 230 may identify the one or more insurers based on information stored by bidding manager 230. For example, bidding manager 230 may store information (e.g., a list of insurers) that identifies multiple insurers that are to be provided with bidding information associated with all drivers (e.g., the multiple insurers may be provided with bidding information associated with any driver that submits a bid request). In some implementations, the one or more insurers may each enter into an agreement with a service provider, associated with bidding manager 230, indicating that the one or more insurers are to be provided with the bidding information, and bidding manager 230 may store information indicating that the one or more insurers are to be provided with the bidding information based on the agreements.

Additionally, or alternatively, bidding manager 230 may identify the one or more insurers based on information included in the bid request. For example, the bid request may include information indicating a driver age of the driver (e.g., seventeen years), and bidding manager 230 may identify the one or more insurers based on the driver age (e.g., when bidding manager 230 stores information indicating that a first insurer is not to be provided with bidding information associated with any driver under the age of eighteen years, when bidding manager 230 stores information indicating that a second insurer is to be provided with bidding information associated with a driver of any age, etc.). As another example, the bid request may include information identifying the one or more insurers (e.g., when the user specifies the one or more insurers in the bid request).

Additionally, or alternatively, bidding manager 230 may identify the one or more insurers based on information stored by driver information device 240. For example, bidding manager 230 may receive the bid request, and may determine a scope of the driver information, associated with the driver, stored by driver information device 240. In this example, bidding manager 230 may identify the one or more insurers based on the scope of driver information stored by driver information device 240 (e.g., when a first insurer is to be provided with bidding information associated with the driver only when driver information device 240 stores driver information associated with vehicle acceleration information, when a second insurer is to be provided with bidding information associated with the driver regardless of the scope of the driver information stored by driver information device 240).

In some implementations, bidding manager 230 may identify the one or more insurers, and may store information (e.g., a list) that identifies the one or more insurers in a memory location (e.g., RAM) of bidding manager 230, such that bidding manager 230 may reference, retrieve, and/or modify the information that identifies the one or more insurers at a later time (e.g., to determine whether each of the one or more insurers has been provided with bidding information, as discussed below).

As further shown in FIG. 6, process 600 may include determining a subscription type associated with an insurer of the one or more insurers (block 630). For example, bidding manager 230 may determine a subscription type associated with an insurer of the one or more insurers that are to be provided with bidding information associated with the driver. In some implementations, bidding manager 230 may determine the subscription type associated with the insurer when bidding manager 230 identifies the one or more insurers (e.g., after bidding manager 230 identifies the one or more insurers). Additionally, or alternatively, bidding manager 230 may determine the subscription type associated with an insurer after bidding manager 230 provides bidding information to another insurer, as discussed below.

A subscription type associated with an insurer may include information that identifies a scope of bidding information with which the insurer is to be provided. For example, a first insurer associated with a first subscription type (e.g., premium, gold, type 1, etc.) may be provided with first bidding information, and a second insurer associated with a second subscription type (e.g., basic, silver, type 2, etc.) may be provided with second bidding information. In this example, the first bidding information and the second bidding information may be of differing scope (e.g., the first bidding information may include driver information that is not included and/or is different than driver information included in the second bidding information), as discussed below. In some implementations, the subscription type may be based on an agreement between the insurer and the service provider associated with bidding manager 230 (e.g., the insurer may agree to be provided with bidding information, associated with the subscription type, from the service provider).

Additionally, or alternatively, the subscription type may be based on an agreement between the driver and the service provider associated with bidding manager 230. For example, a first driver, associated with a first subscription type (e.g., premium, gold, type 1, etc.), may enter into an agreement (e.g., with the service provider) such that the one or more insurers are provided with first bidding information, and a second driver, associated with a second subscription type (e.g., basic, silver, type 2, etc.), may enter into an agreement such that the one or more insurers are provided with second bidding information. In this example, the first bidding information and the second bidding information may be of differing scope (e.g., the first bidding information may include driver information that is not included and/or is different than driver information included in the second bidding information). As another example, a driver may enter into an agreement indicating that the bidding information is to include a particular type of driver information (e.g., when the driver wishes to limit the types of driver information that are included in the bidding information). In some implementations, the subscription type, associated with the agreement between the driver and the service provider, may indicate a scope of the driver information that is to be made available to bidding information 230 (e.g., for bidding manager 230 to include in the bidding information). In other words, the scope of the driver information, available to bidding manager 230 to include in the bidding information, may vary based on the agreement between the driver and the service provider.

In some implementations, bidding manager 230 may determine the subscription type associated with the insurer based on information stored by bidding manager 230. For example, bidding manager 230 may store information (e.g., a list), that includes information that identifies a subscription type that corresponds to each insurer of the one or more insurers, and bidding manager 230 may determine the subscription type, associated with the insurer, based on the stored information. As another example, bidding manager 230 may store information that identifies a subscription type that corresponds to the driver, and bidding manager may determine the subscription type, associated with the insurer, based on the stored information.

As further shown in FIG. 6, process 600 may include determining the bidding information based on the subscription type, the request, and driver information associated with the driver (block 640). For example, bidding manager 230 may determine bidding information, to be provided to the insurer, based on the subscription type associated with the insurer, based on the request for vehicle insurance bids, and based on driver information associated with the driver. In some implementations, bidding manager 230 may determine the bidding information when bidding manager 230 determines the subscription type associated with the insurer. Additionally, or alternatively, bidding manager 230 may determine the bidding information when bidding manager 230 receives driver information, associated with the driver, from driver information device 240. Additionally, or alternatively, bidding manager 230 may determine the bidding information when bidding manager 230 receives the bid request from user device 210.

As defined above, bidding information may include information, associated with a driver, that may be used (e.g., by insurer device 250 associated with the insurer) to generate a vehicle insurance bid. In some implementations, the bidding information may include the driver information associated with the driver (e.g., the bidding information may include all driver information, associated with the driver, stored by driver information device 240). Alternatively, the bidding information may include a portion of the driver information associated with the driver (e.g., when the insurer wishes only to be provided with a particular category and/or a particular portion of the driver information associated with the driver). Additionally, or alternatively, the bidding information may include information included in the bid request.

Additionally, or alternatively, the bidding information may include a driver prediction (e.g., a driver behavior prediction, a driver safety prediction, a driver score, a driver rating, a driver risk prediction, etc.) determined, generated, calculated, and/or computed by bidding manager 230. A driver prediction may include a value (e.g., a numerical value between 0 (indicating an unsafe driver) and 100 (indicating a safe driver), etc.) indicating a rating associated with insuring the driver. For example, bidding manager 230 may store a driver prediction model (e.g., a model used to generate a driver prediction), may receive the bid request, may determine (e.g., based on driver information stored by driver information device 240) the driver information associated with the driver, and may generate the driver prediction by inputting information included in the bid request and the driver information into the driver prediction model.

In some implementations, bidding manager 230 may determine the bidding information based on the subscription type associated with the insurer. For example, a first insurer may be associated with a first subscription type (e.g., premium, gold, type 1, etc.) that permits the first insurer to be provided with raw driver information associated with the driver (e.g., such that the first insurer may use the raw driver information to generate a vehicle insurance bid based on a model designed by the first insurer). As an additional example, a second insurer may be associated with a second subscription type (e.g., basic, silver, type 2, etc.) that permits the second insurer to be provided with only a driver prediction (e.g., a driver score, a driver rating) associated with the driver (e.g., rather than the raw driver information). In this way, bidding manager 230 may determine bidding information of a different scope for each of the one or more insurers. In some implementations, bidding manager 230 may determine the scope of bidding information to be provided to the insurer based on an agreement between the insurer and the service provider associated with bidding manager 230, as discussed above.

Additionally, or alternatively, bidding manager 230 may determine the scope of bidding information to be provided to the insurer based on an agreement between the driver and the service provider associated with bidding manager 230.

As further shown in FIG. 6, process 600 may include providing the bidding information (block 650). For example, bidding manager 230 may provide the bidding information to insurer device 250. In some implementations, bidding manager 230 may provide the bidding information when bidding manager 230 determines the bidding information (e.g., after bidding manager 230 determines the bidding information). Additionally, or alternatively, bidding manager 230 may provide the bidding information when bidding manager 230 determines other bidding information to be provided to another insurer (e.g., after bidding manager 230 determines bidding information for each of the one or more insurers).

In some implementations, bidding manager 230 may provide (e.g., via network 220) the bidding information to insurer device 250, associated with the insurer, and insurer device 250 may generate a vehicle insurance bid, associated with the driver, based on the bidding information. For example, bidding manager 230 may provide the bidding information, and insurer device 250 may generate a vehicle insurance bid using a bid generator model and/or another method used by insurer device 250.

As further shown in FIG. 6, process 600 may include determining whether each insurer, of the one or more insurers, has been provided with bidding information (block 660). For example, bidding manager 230 may determine whether each insurer, of the one or more insurers, has been provided with bidding information. In some implementations, bidding manager 230 may determine whether each insurer has been provided with bidding information when bidding manager 230 provides the bidding information (e.g., after bidding manager 230 provides the bidding information). Additionally, or alternatively, bidding manager 230 may determine whether each of the one or more insurers has been provided with bidding information when bidding manager 230 determines bidding information for the insurer (e.g., when bidding manager 230 is configured to determine bidding information associated with each of the one or more insurers before providing bidding information to any of the one or more insurers).

In some implementations, bidding manager 230 may determine whether each insurer has been provided with bidding information based on information stored by bidding manager 230. For example, bidding manager 230 may store information (e.g., a list) that identifies the one or more insurers, bidding manager 230 may provide bidding information to insurer device 250 associated with a particular insurer of the one or more insurers, may delete the particular insurer from the stored information (e.g., remove the particular insurer from the list), and may determine whether the stored information identifies another insurer (e.g., indicating that the other insurer has not been provided with bidding information). Additionally, or alternatively, bidding manager 230 may determine whether each insurer has been provided with bidding information in another manner.

As further shown in FIG. 6, if each of the one or more insurers has been provided with bidding information (block 660—YES), then process 600 may include ending the determination and provision of bidding information. For example, if bidding manager 230 determines that each insurer, of the one or more insurers, has been provided with bidding information, then bidding manager 230 may not determine and/or provide bidding information to additional insurers.

As further shown in FIG. 6, if each of the one or more insurers has not been provided with bidding information (block 660—NO), then process 600 may return to block 630. For example, if bidding manager 230 determines that each insurer, of the one or more insurers, has not been provided with bidding information, then bidding manager 230 may identify (e.g., based on information stored by bidding manager 230) an insurer that has not been provided with bidding information, and may determine and provide bidding information, associated with the insurer, as described above.

Although FIG. 6 shows example blocks of process 600, in some implementations, process 600 may include additional blocks, different blocks, fewer blocks, or differently arranged blocks than those depicted in FIG. 6. Additionally, or alternatively, one or more of the blocks of process 600 may be performed in parallel.

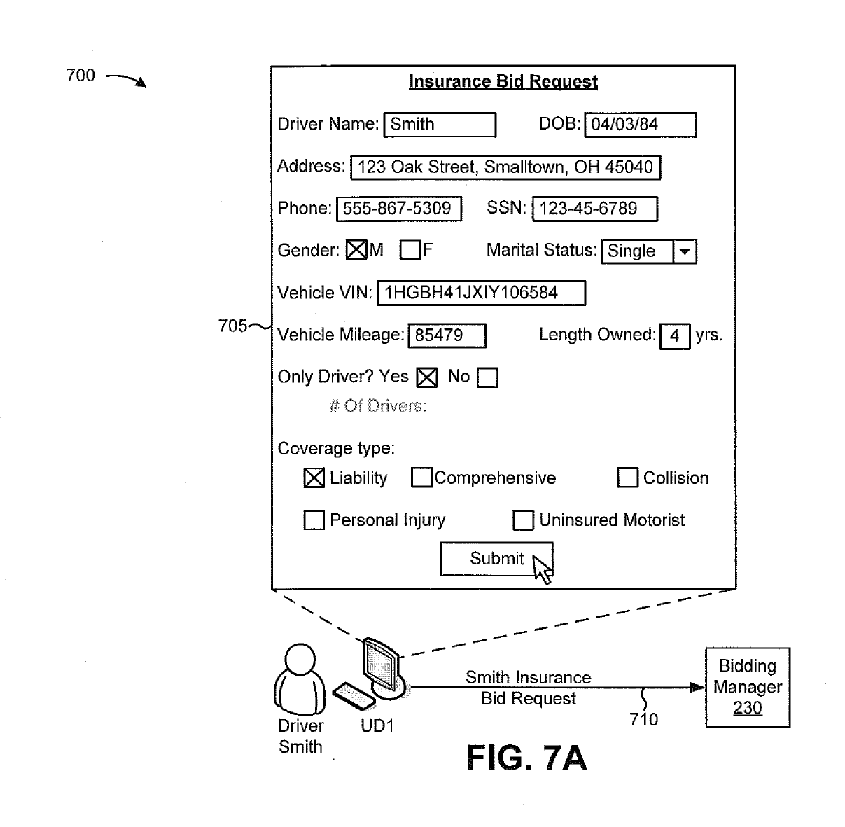

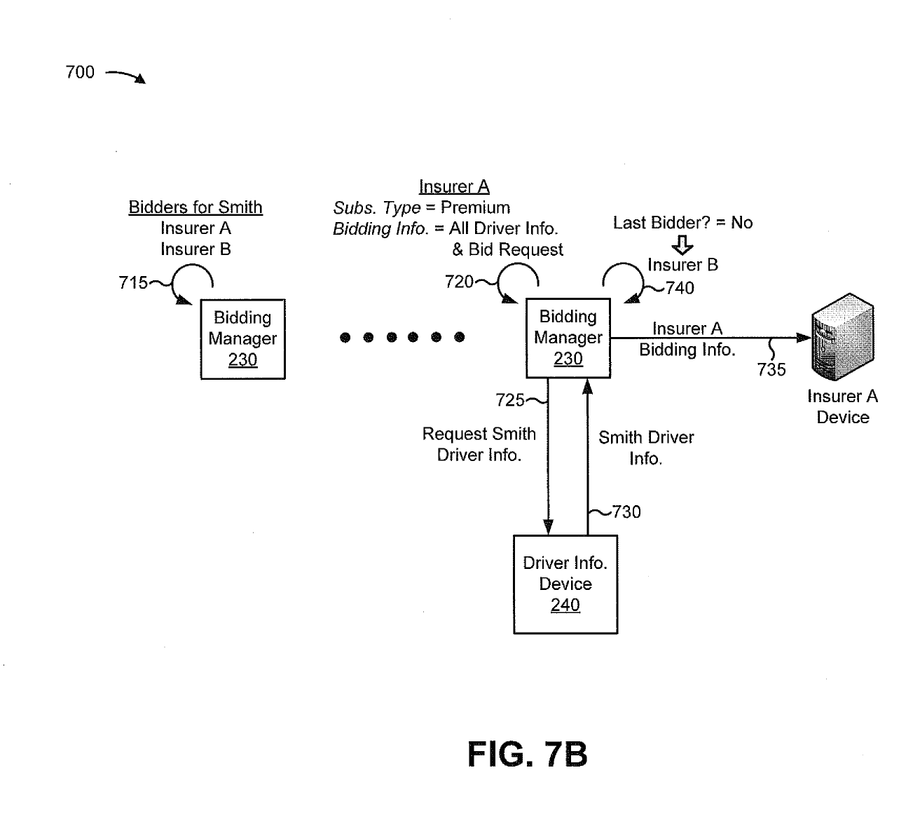

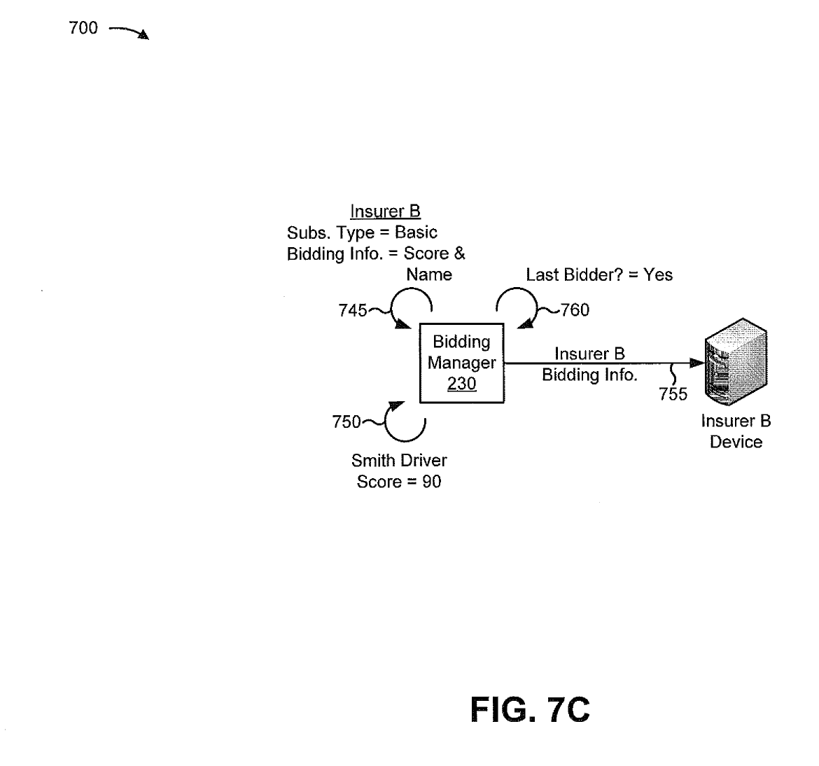

FIGS. 7A-7C are diagrams of an example implementation 700 relating to example process 600 shown in FIG. 6. For the purposes of example implementation 700, assume that a driver, Smith, wishes to obtain vehicle insurance bids from one or more insurers. Further, assume that driver information device 240 stores driver information associated with the driver. Finally, assume that bidding manager 230 hosts a website that allows the driver to fill out (e.g., via a user device, UD1) a vehicle insurance bid request form associated with obtaining vehicle insurance bids from the one or more insurers.

As shown in FIG. 7A, and by reference number 705, the driver may provide (e.g., via UD1) input associated with the bid request via a user interface associated with the website hosted by bidding manager 230. As shown, the driver may provide (e.g., via one or more text boxes, check boxes, drop down menus, etc.) information associated with the driver (e.g., Driver Name: Smith, DOB: Apr. 3, 1984, Address: 123 Oak Street, Smalltown, Ohio 45040, Phone: 555-867-5309, SSN: 123-45-6789, Gender: M, Marital Status: Single), information associated with a vehicle associated with the driver (e.g., Vehicle VIN: 1HGBH41JXIY106584, Vehicle Mileage: 85479, Length Owned: 4 years, Only Driver: Yes), and information indicating a type of vehicle insurance sought by the driver (e.g., Coverage Type: Liability). As further shown, the driver may indicate (e.g., by selecting a Submit button) that user wishes for UD1 to send the bid request to bidding manager 230. As shown by reference number 710, UD1 may provide the bid request to bidding manager 230 and bidding manager 230 may receive the bid request.

As shown in FIG. 7B, and by reference number 715, bidding manager 230 may identify one or more insurers that are to receive bidding information associated with the driver. For the purposes of example implementation 700, assume that bidding manager 230 stores information indicating that two insurers, insurer A and insurer B, have each entered into an agreement with a service provider associated with bidding manager 230, and that the agreements indicate that insurer A and insurer B are to be provided with bidding information associated any driver that submits a bid request. As such, bidding manager 230 may identify that insurer A and insurer B are to be provided with bidding information associated with the driver.

As shown by reference number 720, bidding manager 230 may determine that a subscription type associated with insurer A is a premium subscription type, and that insurer A is to be provided with bidding information that includes all available driver information associated with the driver and information included in the bid request (e.g., such that insurer A may input the information into its own driver prediction model).

As shown by reference number 725, bidding manager 230 may send a request to driver information device 240 to provide the driver information associated with the driver. As shown by reference number 730, driver information device 240 may provide the driver information to bidding manager 230. As shown by reference number 735, bidding manager 230 may determine insurer A bidding information (e.g., including all of the driver information and the information included in the bid request) and may provide the insurer A bidding information to a device associated with insurer A (shown as insurer A device).

As shown by reference number 740, bidding manager 230 may determine (e.g., based on the one or more insurers identified with respect reference number 715) that another insurer, insurer B, has not been provided with bidding information associated with the driver (e.g., since bidding manager 230 has yet to provide bidding information to insurer B).

As shown in FIG. 7C, and by reference number 745, bidding manager 230 may determine that a subscription type associated with insurer B is a basic subscription type, and that insurer B is to be provided with bidding information that includes a driver score and a driver name only (e.g., such that insurer A may generate a vehicle insurance bid based on a driver score determined by bidding manager 230).

As shown by reference number 750, bidding manager 230 may determine insurer B bidding information by computing a driver score (e.g., by inputting the driver information received from driver information device 240 and/or the information included in the bid request into a driver prediction model stored by bidding manager 230). For purposes of example implementation 700, assume that bidding manager 230 determines that the driver score for Smith is 90 (e.g., out of a possible 100). As shown by reference number 755, bidding manager 230 may provide the insurer B bidding information (e.g., including the name of the driver and the driver score, 90) to a device associated with insurer B (shown as insurer B device).

As shown by reference number 760, bidding manager 230 may determine (e.g., based on the one or more insurers identified with respect reference number 715) that all identified insurers have been provided with bidding information associated with the driver (e.g., since bidding manager 230 has provided bidding information to insurer A and insurer B), and bidding manager 230 may stop determining and providing bidding information to additional insurers.

As indicated above, FIGS. 7A-7C are provided merely as an example. Other examples are possible and may differ from what was described with regard to FIGS. 7A-7C.

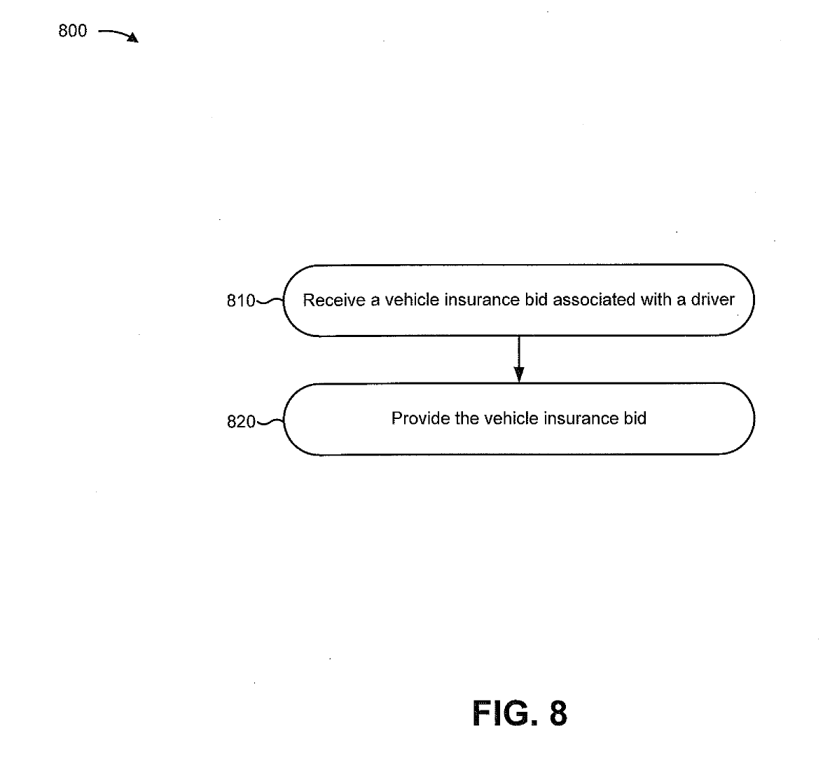

FIG. 8 is a flow chart of an example process 800 for receiving and providing vehicle insurance bids associated with a driver. In some implementations, one or more process blocks of FIG. 8 may be performed by bidding manager 230. In some implementations, one or more process blocks of FIG. 8 may be performed by another device or a group of devices separate from or including bidding manager 230, such as driver information device 240.

As shown in FIG. 8, process 800 may include receiving a vehicle insurance bid associated with a driver (block 810). For example, bidding manager 230 may receive, from insurer device 250, a vehicle insurance bid associated with a driver. In some implementations, bidding manager 230 may receive the insurance bid (herein referred to as a bid) when bidding manager 230 provides bidding information to insurer device 250 associated with an insurer (e.g., after bidding manager 230 provides bidding information to insurer device 250). Additionally, or alternatively, bidding manager 230 may receive the bid when insurer device 250 provides the bid (e.g., after insurer device 250 is provided with bidding information and generates the bid).

A vehicle insurance bid may include information, associated with an insurer, that indicates an offer to provide vehicle insurance to a driver. For example, the bid may include information that identifies the insurer (e.g., a name of the insurer), a type of the vehicle insurance (e.g., liability, comprehensive, collision, etc.), a cost of the vehicle insurance (e.g., a quantity of U.S. dollars), a length of the vehicle insurance contract term (e.g., 6 months, 12 months, etc.), and/or other information associated with the offer (e.g., an offer for a conditional discount, an offer for a vehicle insurance upgrade, etc.). In some implementations, the bid may be based on driver information and/or a bid request associated with the driver provided by bidding manager 230, as discussed above.

In some implementations, bidding manager 230 may receive (e.g., from insurer devices 250) multiple bids associated with the driver, where each bid of the multiple bids corresponds to a different insurer (e.g., when bidding manager 230 provides bidding information to one or more insurers, as discussed above). Additionally, or alternatively, bidding manager 230 may receive multiple bids from a single insurer device 250 (e.g., a first bid associated with a first type of vehicle insurance offered by the single insurer, a second bid associated with a second type of vehicle insurance offered by the single insurer, etc.).

As further shown in FIG. 8, process 800 may include providing the vehicle insurance bid (block 820). For example, bidding manager 230 may provide the vehicle insurance bid to user device 210. In some implementations, bidding manager 230 may provide the bid to user device 210 when bidding manager 230 receives the bid from insurer device 250. Additionally, or alternatively, bidding manager 230 may provide the bid when bidding manager 230 determines that bidding manager 230 is to provide the bid (e.g., after bidding manager 230 determines that bidding manager 230 has received one or more bids from one or more insurers).

In some implementations, bidding manager 230 may provide the bid based on a threshold quantity of time being satisfied. For example, bidding manager 230 may provide bidding information to insurer device 250, and bidding manager 230 may be configured to accept a bid, provided by insurer device 250, as long as bidding manager 230 receives the bid before a threshold amount of time (e.g. 30 seconds, 5 minutes, etc.) is satisfied. In this example, if bidding manager 230 receives the bid from insurer device 250 before the threshold amount of time is satisfied (e.g., less than 30 seconds after bidding manager 230 provides the bidding information to insurer device 250), then bidding manager 230 may provide the bid to user device 210. Similarly, if bidding manager 230 receives the bid from insurer device 250 after the threshold amount of time is satisfied (e.g., more than 30 seconds after bidding manager 230 provides the bidding information), then bidding manager 230 may not provide the bid to user device 210.

As another example, bidding manager 230 may provide bidding information to a group of insurer devices 250 and may initiate a timer (e.g., a 30 second timer) after the last bidding information is provided to the last insurer device 250 in the group of insurer devices 250. In this example, bidding manager 230 may receive one or more bids from one or more insurer devices 250 of the group before the 30 second threshold is satisfied, and may provide the one or more bids when the 30 second threshold is satisfied (e.g., and may not provide a bid received after the 30 second threshold is satisfied).

Additionally, or alternatively, bidding manager 230 may provide the bid based on receiving one or more bids from one or more insurer devices 250. For example, bidding manager 230 may provide bidding information to a group of insurer devices 250, and may receive a bid from each insurer device 250 of the group of insurer devices 250. In this example, bidding manager 230 may determine (e.g., based on information stored by bidding manager 230) that bidding manager 230 has received a bid from each insurer device 250 of the group of insurer devices, and bidding manager 230 may provide the bids to user device 210 (e.g., since bidding manager 230 has received a bid from all of the insurer devices 250).

In some implementations, bidding manager 230 may provide a bid to user device 210, and user device 210 may display information associated with the bid to the driver (e.g., and the driver may choose to accept the bid). Additionally, or alternatively, bidding manager 230 may provide multiples bids to user device 210, user device 210 may display information associated with the multiple bids, and the driver, associated with user device 210, may view and/or select a particular bid of the multiple bids. In some implementations, the driver may complete the purchase of the vehicle insurance associated with a bid via user device 210, bidding manager 230, and/or insurer device 250 (e.g., such that the driver does not have to navigate to another website to complete the purchase of the vehicle insurance).

In some implementations, bidding manager 230 may provide a bid, associated with a first insurer device 250, to a second insurer device 250, and bidding manager 230 may receive an updated bid from the second insurer device 250. For example, bidding manager may receive a first bid (e.g., $500 for six months of liability insurance) from a first insurer device 250 associated with a first insurer, and may receive a second bid (e.g., $490 for six months of liability insurance) from a second insurer device 250 associated with a second insurer. In this example, bidding manager 230 may provide information associated with the second bid (e.g., the lower bid) to the first insurer device 250, such that the first insurer device 250 may have a chance to provide, to bidding manager 230, a revised first bid (e.g., $485 for six months of liability insurance) in an attempt to outbid the second insurer device 250 or match the second bid provided by the second insurer device 250. Continuing this example, bidding manager 230 may provide information associated with the revised first bid to the second insurer device 250, such that the second insurer device 250 may have a chance to provide a revised second bid (e.g., $480 for six months of liability insurance) in an attempt to outbid the first insurer device 250 or to match the revised first bid. This bidding process may continue with any number of insurer devices 250 and/or revised bids, until a final (e.g., minimum) bid for each insurer has been received and is provided to user device 210.

Although FIG. 8 shows example blocks of process 800, in some implementations, process 800 may include additional blocks, different blocks, fewer blocks, or differently arranged blocks than those depicted in FIG. 8. Additionally, or alternatively, one or more of the blocks of process 800 may be performed in parallel.

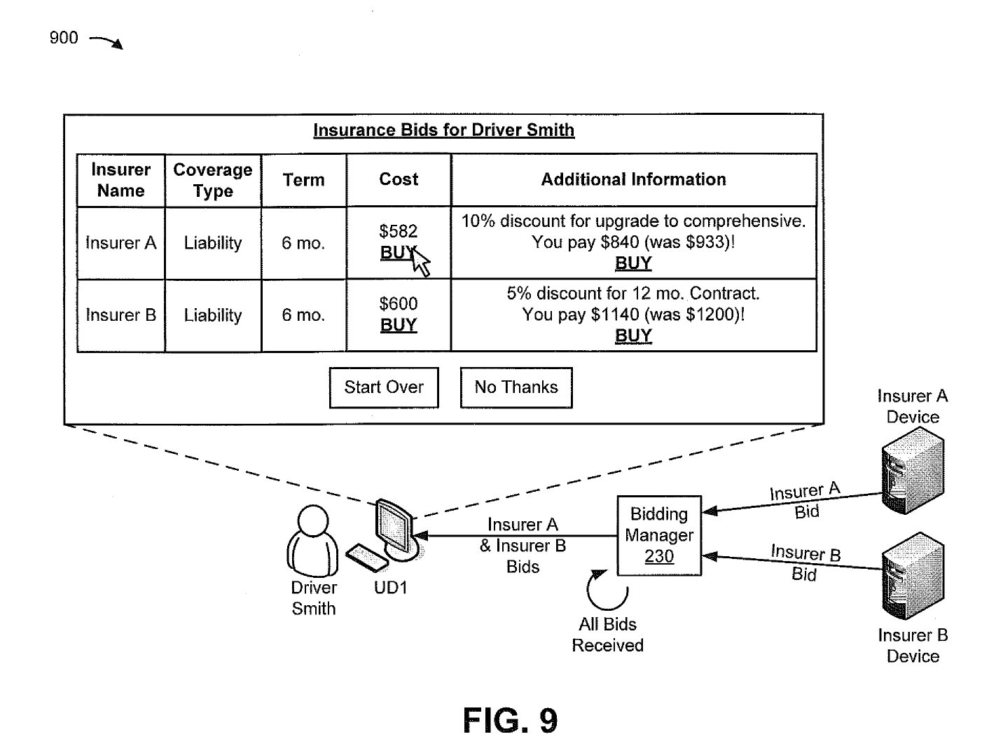

FIG. 9 is a diagram of an example implementation 900 relating to example process 800 shown in FIG. 8. For the purposes of example implementation 900, assume that bidding manager 230 has provided insurer A bidding information to an insurer A device, and that bidding manager 230 has provided insurer B bidding information to an insurer B device. Further assume that the insurer A device and the insurer B device are each configured to generate a vehicle insurance bid, associated with the driver, and provide their respective vehicle insurance bids to bidding manager 230.

As shown in FIG. 9, the insurer A device may generate and provide an insurer A bid, associated with the driver, to bidding manager 230. As further shown, the insurer B device may generate and provide an insurer B bid, associated with the driver, to bidding manager 230. As further shown, bidding manager 230 may receive the insurer A bid and the insurer B bid, and may determine (e.g., based on information indicating that insurer A and insurer B are the only two insurers that were provided with bidding information associated with the driver) that bidding manager 230 has received all bids associated with the driver.

As further shown, bidding manager 230 may provide the insurer A bid and the insurer B bid to UD1, associated with the driver, and UD1 may display information associated with the insurer A bid and information associated with the insurer B bid. As shown, the information associated with insurer A bid may include information identifying the insurer associated with the insurer A bid (e.g., insurer A), information identifying a coverage type associated with the insurer A bid (e.g., liability), information indicating a contract length associated with the insurer A bid (e.g., 6 months), information indicating a cost of the vehicle insurance associated with the insurer A bid (e.g., $582), and additional information associated with a potential coverage upgrade provided by insurer A (e.g., 10% discount for upgrade to comprehensive. You pay $840 (was $933)!).

As further shown, the information associated with insurer B bid may include information identifying the insurer B associated with the insurer B bid (e.g., insurer B), information identifying a coverage type associated with the insurer B bid (e.g., liability), information indicating a contract length associated with the insurer B bid (e.g., 6 months), information indicating a cost of the vehicle insurance associated with the insurer B bid (e.g., $600), and additional information associated with a potential coverage upgrade provided by insurer B (e.g., 5% discount for 12 month contract. You pay $1140 (was $1200)!).

As further shown, the driver may view the information associated with the insurer A bid and the insurer B bid, and may indicate (e.g., by selecting a BUY link) that the driver wishes to purchase vehicle insurance associated with the $582 insurer A bid. The driver may then complete the purchase of the vehicle insurance via UD1 and bidding manager 230.

As indicated above, FIG. 9 is provided merely as an example. Other examples are possible and may differ from what was described with regard to FIG. 9.

Implementations described herein may allow a driver to provide (e.g., via a single website) information associated with vehicle insurance that the driver wishes to obtain, and may allow the driver to receive multiple vehicle insurance bids from multiple insurers at one time. In this way, the driver may determine a cost of the vehicle insurance made available through each insurer without the driver seeking out a vehicle insurance quote from each insurer individually.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms.

Certain user interfaces have been described herein. In some implementations, the user interfaces may be customizable by a device or a user. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, as described herein, may be implemented in many different forms of software, firmware, and hardware in the implementations shown in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive a request for a vehicle insurance bid,
the request identifying a driver, and
the request identifying a vehicle associated with the driver;
identify, based on receiving the request, an insurer that is to be provided with vehicle insurance bidding information associated with the driver and the vehicle;
determine a subscription type associated with the insurer,
the subscription type indicating a scope of the vehicle insurance bidding information that is to be provided to the insurer;
determine the vehicle insurance bidding information,
the vehicle insurance bidding information being determined based on the subscription type, the request, and driver information,
the driver information being information associated with the driver and/or the vehicle;
provide the vehicle insurance bidding information to an insurer device associated with the insurer;
receive a vehicle insurance bid after providing the vehicle insurance bidding information; and
provide the vehicle insurance bid,
the vehicle insurance bid being provided such that the driver can purchase vehicle insurance associated with the vehicle insurance bid.

2. The device of claim 1, where the one or more processors are further to:
receive information identifying the subscription type associated with the insurer;
store the information identifying the subscription type; and
where the one or more processors, when determining the subscription type associated with the insurer, are further to:
determine the subscription type based on the stored information.

3. The device of claim 1, where the one or more processors are further to:
determine, based on the subscription type, that the insurer is to be provided with driver information associated with a first category of driver information;
receive the driver information from a driver information device,
the driver information comprising driver information associated with the first category of driver information and driver information associated with a second category of driver information; and
identify the driver information associated with the first category of driver information; and
where the one or more processors, when determining the vehicle insurance bidding information, are further to:
determine the vehicle insurance bidding information based on identifying the driver information associated with the first category of driver information.

4. The device of claim 1, where the one or more processors are further to:
determine, based on the subscription type, that the insurer is to be provided with a driver prediction associated with the driver;
receive the driver information from a driver information device;
generate the driver prediction based on the driver information; and
where the one or more processors, when determining the vehicle insurance bidding information, are further to:
determine the vehicle insurance bidding information based on the driver prediction.

5. The device of claim 1, where the insurer is a first insurer, the subscription type is a first subscription type, the vehicle insurance bidding information is first vehicle insurance bidding information, and the vehicle insurance bid is a first vehicle insurance bid,
the first vehicle insurance bidding information being determined based on the request, the first subscription type, and the driver information; and
where the one or more processors are further to:
identify a second insurer that is to be provided with second vehicle insurance bidding information,
the second insurer being different from the first insurer;
determine a second subscription type associated with the second insurer,
the second subscription type being different from the first subscription type;
determine second vehicle insurance bidding information,
the second vehicle insurance bidding information being different from the first vehicle insurance bidding information;
provide the second vehicle insurance bidding information to an insurer device associated with the second insurer;
receive a second vehicle insurance bid after providing the second vehicle insurance bidding information; and
provide the first vehicle insurance bid and the second vehicle insurance bid,
the first vehicle insurance bid and the second vehicle insurance bid being provided such that the driver can purchase vehicle insurance associated with the first vehicle insurance bid or vehicle insurance associated with the second vehicle insurance bid.

6. The device of claim 1, where the one or more processors are further to:
determine agreement information, associated with the insurer, that identifies a required category of driver information,
the required category of driver information being a category of driver information that must be included in vehicle insurance bidding information provided to the insurer;
determine that driver information, included in the required category of driver information, is available; and
where the one or more processors, when identifying the insurer that is to be provided with the vehicle insurance bidding information, are further to:
identify the insurer based on determining that the driver information, included in the required category of driver information, is available.

7. The device of claim 1, where the vehicle insurance bid is a first vehicle insurance bid and the insurer is a first insurer;
where the one or more processors are further to:
receive a second vehicle insurance bid associated with a second insurer;
determine that a first cost, associated with the first vehicle insurance bid, is less than a second cost associated with the second vehicle insurance bid; and
provide information associated with the first cost to an insurer device associated with the second insurer,
the information associated with the first cost being provided to allow the second insurer to provide a revised second vehicle insurance bid associated with a third cost,
the third cost being the same as or less than the first cost.

8. A computer-readable medium storing instructions, the instructions comprising:
one or more instructions that, when executed by one or more processors, cause the one or more processors to:
receive a bid request for a vehicle insurance bid,
the bid request including information identifying a driver and information identifying a vehicle associated with the driver;
determine that an insurer is to be provided with bidding information associated with the driver and the vehicle;
identify a subscription type, associated with the insurer, that indicates a scope of the bidding information;
determine the bidding information based on the subscription type, the bid request, and driver information associated with the driver,
the driver information being information associated with the driver and/or the vehicle;
send the bidding information to an insurer device associated with the insurer;
receive a vehicle insurance bid after sending the bidding information; and
provide the vehicle insurance bid to allow the driver to purchase vehicle insurance based on information included in the vehicle insurance bid.

9. The computer-readable medium of claim 8, where the one or more instructions, when executed by the one or more processors, further cause the one or more processors to:
receive agreement information indicating that the insurer is to be provided with bidding information based on a bid request associated with any driver; and
where the one or more instructions, that cause the one or more processors to determine that the insurer is to be provided with the bidding information, further cause the one or more processors to:
determine that the insurer is to be provided with the bidding information based on the agreement information.

10. The computer-readable medium of claim 8, where the one or more instructions, when executed by the one or more processors, further cause the one or more processors to:
determine, based on the subscription type, that the insurer is to be provided with a first portion of the driver information,
the driver information comprising a first portion and a second portion;
receive the first portion of the driver information from a driver information device; and
where the one or more instructions, that cause the one or more processors to determine the bidding information, further cause the one or more processors to:
determine the bidding information based on the first portion of the driver information and not based on the second portion of the driver information.

11. The computer-readable medium of claim 8, where the one or more instructions, when executed by the one or more processors, further cause the one or more processors to:
determine, based on the subscription type, that the insurer is to be provided with a driver score associated with the driver;
receive the driver information from a driver information device;
generate the driver score based on the driver information; and
where the one or more instructions, that cause the one or more processors to determine the bidding information, further cause the one or more processors to:
determine the bidding information based on the driver score.

12. The computer-readable medium of claim 8, where the insurer is a first insurer, the subscription type is a first subscription type, the bidding information is first bidding information, and the vehicle insurance bid is a first vehicle insurance bid,
the first bidding information being determined based on the bid request, the first subscription type, and the driver information; and
where the one or more instructions, when executed by the one or more processors, further cause the one or more processors to:
identify a second insurer that is to be provided with second bidding information,
the second insurer being different from the first insurer;
determine a second subscription type associated with the second insurer,
the second subscription type being different from the first subscription type;
determine second bidding information,
the second bidding information being different from the first bidding information;
provide the second bidding information to an insurer device associated with the second insurer;
receive a second vehicle insurance bid after providing the second bidding information; and
provide the first vehicle insurance bid and the second vehicle insurance bid,
the first vehicle insurance bid and the second vehicle insurance bid being provided to permit the driver to purchase vehicle insurance associated with the first vehicle insurance bid or vehicle insurance associated with the second vehicle insurance bid.

13. The computer-readable medium of claim 8, where the one or more instructions, when executed by the one or more processors, further cause the one or more processors to:
determine agreement information, associated with the insurer, that identifies a required category of driver information,
the required category of driver information being a category of driver information that must be included in bidding information provided to the insurer;
determine that driver information, included in the required category of driver information, is available; and
where the one or more instructions, that cause the one or more processors to determine that the insurer is to be provided with the bidding information, further cause the one or more processors to:
determine that the insurer is to be provided with the bidding information based on determining that the driver information, included in the required category of driver information, is available.

14. The computer-readable medium of claim 8, where the vehicle insurance bid is a first vehicle insurance bid and the insurer is a first insurer;
where the one or more instructions, when executed by the one or more processors, further cause the one or more processors to:
receive a second vehicle insurance bid associated with a second insurer;
determine that a first cost, associated with the first vehicle insurance bid, is less than a second cost associated with the second vehicle insurance bid;
provide information associated with the first cost to an insurer device associated with the second insurer;
receive, from the insurer device associated with the second insurer, a revised second vehicle insurance bid,
the revised second vehicle insurance bid being associated with a third cost,
the third cost being the same as or less than the first cost; and
provide the first vehicle insurance bid and the revised second vehicle insurance bid to allow the driver to purchase vehicle insurance based on information included in the first vehicle insurance bid or vehicle insurance based on information included in the revised second vehicle insurance bid.

15. A method, comprising:
receiving, by a device, a request for insurance bids,
the request including information identifying a driver and information identifying a vehicle,
the vehicle being associated with the driver;
identifying, by the device, insurers that are to be provided with bidding information associated with the driver and the vehicle;
determining, by the device, a first subscription type associated with a first insurer of the insurers,
the first subscription type indicating a scope of first bidding information that is to be provided to the first insurer;
determining, by the device, the first bidding information associated with the first insurer,
the first bidding information being determined based on the first subscription type, the request, and driver information,
the driver information being information associated with the driver and/or the vehicle;
providing, by the device, the first bidding information to a first insurer device associated with the first insurer;
determining, by the device, a second subscription type associated with a second insurer of the insurers,
the second subscription type indicating a scope of second bidding information that is to be provided to the second insurer;
determining, by the device, the second bidding information associated with the second insurer,
the second bidding information being determined based on the second subscription type, the request, and the driver information;
providing, by the device, the second bidding information to a second insurer device associated with the second insurer;
receiving, by the device, a first insurance bid, associated with the first insurer, and a second insurance bid, associated with the second insurer; and
providing, by the device and via a website, the first insurance bid and the second insurance bid,
the first insurance bid and the second insurance bid being provided to permit the driver to purchase vehicle insurance associated with the first insurance bid and the second insurance bid via the website.

16. The method of claim 15, further comprising:
receiving information identifying the first subscription type associated with the first insurer;
storing the information identifying the first subscription type; and
where the one or more processors, when determining the first subscription type associated with the first insurer, are further to:
determining the first subscription type based on the stored information.

17. The method of claim 15, further comprising:
determining, based on the first subscription type, that the first insurer is to be provided with driver information included in a first category of driver information;
receiving the driver information from a driver information device,
the driver information comprising driver information included in the first category of driver information and driver information included in a second category of driver information;
identifying the driver information included in the first category of driver information; and
where determining the first bidding information further comprises:
determining the first bidding information based on the driver information included in the first category of driver information and not based on the driver information included in the second category of driver information.

18. The method of claim 15, further comprising:
determining, based on the second subscription type, that the second insurer is to be provided with a driver prediction associated with the driver;
determining the driver prediction based on the driver information; and
where determining the second bidding information further comprises:
determining the second bidding information based on the driver prediction.

19. The method of claim 15, where the driver information includes at least one of:
driver behavior information;
driver biographical information;
a risk prediction associated with the driver;
vehicle usage information; or
vehicle mileage information.

20. The method of claim 15, where receiving the first insurance bid and the second insurance bid further comprises:
determining that a first cost, associated with the first insurance bid, is less than a second cost associated with the second insurance bid;
providing information associated with the first cost to the second insurer device;
receiving, from the second insurer device, a revised second insurance bid,
the revised second insurance bid being associated with a third cost,
the third cost being the same as or less than the first cost; and
providing information associated with the third cost to the first insurer device,
the information associated with the third cost being provided to allow the first insurer device to provide a revised first insurance bid associated with a fourth cost,
the fourth cost being the same as or less than the third cost.
